(19) United States
(12) Patent Application Publication
(10) Pub. No.: US 2019/0155922 A1
(43) Pub. Date: May 23, 2019

(54) SERVER FOR TORUS NETWORK-BASED DISTRIBUTED FILE SYSTEM AND METHOD USING THE SAME

(71) Applicant: ELECTRONICS AND TELECOMMUNICATIONS RESEARCH INSTITUTE, Daejeon (KR)

(72) Inventors: Young-Chang KIM, Daejeon (KR); Young-Kyun KIM, Daejeon (KR); Hong-Yeon KIM, Daejeon (KR); Jeong-Sook PARK, Daejeon (KR); Joon-Young PARK, Daejeon (KR)

(21) Appl. No.: 16/176,809

(22) Filed: Oct. 31, 2018

(30) Foreign Application Priority Data
Nov. 22, 2017 (KR) 10-2017-0156483

(51) Int. Cl. G06F 17/30; G06F 3/06

(52) U.S. Cl. CPC G06F 17/30203; G06F 3/0643; G06F 3/0625; G06F 3/0647; G06F 3/067

(57) ABSTRACT

Disclosed herein are a server for a torus network-based distributed file system and a method using the server. A management server includes a system information storage unit for storing system information of a torus network-based distributed file system, a system management unit for managing one or more metadata servers that store metadata of files and multiple data servers that are included in the torus network to distribute and store data, and a communication unit for communicating with a switch connected from a first plane in the torus network or from outside the torus network to a client, and communicating with the metadata servers and the data servers.

### CROSS REFERENCE TO RELATED APPLICATION

This application claims the benefit of Korean Patent Application No. 10-2017-0156483, filed Nov. 22, 2017, which is hereby incorporated by reference in its entirety into this application.

### BACKGROUND OF THE INVENTION

### 1. Technical Field

The present invention relates generally to a server for a torus network-based distributed file system and a method using the server, and more particularly to a method that configures a storage tier based on the topology of data servers on a torus network and applies a duplication policy and a power-saving policy depending on the characteristics of the configured tier.

### 2. Description of the Related Art

In order to provide large-scale (Exabyte-level) storage, a torus network-based distributed file system has been proposed. In the torus network-based distributed file system, data servers are connected to each other over a multidimensional torus network, and a switch is used only for connections between data servers in a first plane and a client. In order for a client to access data servers in a second plane or higher-level planes, which are not directly connected to the switch, each data server may access data through paths established between the client and all data servers by performing a routing function. Therefore, in order to access the data servers in the second plane or the higher-level planes, the client must pass through multiple hops. Thus, as the number of hops increases, the delay time caused by network communication increases. Input/output performance is highest in a plane closest to the client and gradually decreases with increasing distance from the client. Using the difference in performance depending on the locations of planes, the tiers of data servers may be intuitively configured based on planes. The data input/output performance of tiers configured in this way may differ.

Generally, a distributed file system uses a duplication policy for storing the same data in different storage devices to improve data availability. The duplication policy may improve performance as the number of duplicates increases, but on the other hand deteriorates the efficiency with which storage space is used. As technology for overcoming this disadvantage, an erasure coding technique is present. However, the erasure coding technique is generally applied to data stored in an archive tier because the performance thereof is lower than that of the duplication technique.

The above-described background technology is technological information that was possessed by the present applicant to devise the present invention or that was acquired by the present applicant in the course of devising the present invention, and thus such information cannot be construed to be known technology that was open to the public before the filing of the present invention.

### PRIOR ART DOCUMENTS

### Patent Documents

(Patent Document 1) Korean Patent Application Publication No. 10-2016-0121380

### SUMMARY OF THE INVENTION

Accordingly, the present invention has been made keeping in mind the above problems occurring in the prior art, and an object of the present invention is to provide a torus network-based distributed file system that separates and manages metadata and data.

Another object of the present invention is to provide a method for configuring and operating storage tiers for data servers in consideration of the characteristics of a torus network-based distributed file system.

A further object of the present invention is to provide a method for operating storage tiers in a torus network-based distributed file system based on an availability policy including duplicates and an erasure coding technique depending on the characteristics of the storage tiers.

Yet another object of the present invention is to provide a method for operating storage tiers in a torus network-based distributed file system based on a power management policy depending on the characteristics of the storage tiers.

In accordance with an aspect of the present invention to accomplish the above objects, there is provided a management server, including a system information storage unit for storing system information of a torus network-based distributed file system; a system management unit for managing one or more metadata servers that store metadata of files and multiple data servers that are included in the torus network to distribute and store data; and a communication unit for communicating with a switch connected from a first plane in the torus network or from outside the torus network to a client, and communicating with the metadata servers and the data servers.

The system management unit may manage topology information of the data servers and configure multiple tiers for the data servers using the topology information, and the topology information may include location information of axes in respective dimensions in the torus network.

The system management unit may configure the tiers in consideration of one or more of proximity of each of the data servers to the switch and input/output performance of each of the data servers.

The system management unit may configure one or more volumes for the data servers, and each of the volumes may be configured such that configuration of the tiers is determined depending on usage of the volume and such that data is distributed and stored based on erasure coding.

The system management unit may perform migration for data movement between tiers in a volume composed of multiple tiers.

The system management unit may be configured to, when performing migration, identify a migration target inode corresponding to a migration target volume, identify a migration target chunk from the inode, determine a data server located in a migration destination tier, move data to the data server, and then update the migration target inode.

The system management unit may determine power modes for respective tiers, corresponding to the respective tiers, and manage power modes corresponding to the respective data servers based on the power modes for respective tiers at preset periods.

The power modes for respective tiers may be determined in consideration of one or more of performance and an access frequency corresponding to each of the tiers.

The system management unit may be configured to, when a power mode of a target data server is different from a power mode of a tier corresponding to the target data server and a preset time has elapsed since a last task time of the target data server, change the power mode of the target data server to the power mode of the tier corresponding to the target data server.

In accordance with another aspect of the present invention to accomplish the above objects, there is provided a data server, including a data storage unit for storing data managed by a torus network-based distributed file system; a data management unit for managing stored data in response to a data-processing command received from a management server; and a communication unit for communicating with a switch connected from an arbitrary plane in the torus network to a client, either directly or through additional data servers, and communicating with the additional data servers and the management server.

The data management unit may manage data depending on multiple tiers configured by the management server, a volume, and tier configuration corresponding to the volume, the multiple tiers may be configured using topology information including location information of axes in respective dimensions in the torus network, and the tier configuration corresponding to the volume may be determined depending on usage of the volume.

The tiers may be configured in consideration of one or more of proximity of each of the tiers to the switch and input/output performance of each of the tiers.

The data management unit may perform migration for data movement between tiers in a volume composed of multiple tiers.

The data server may further include a power management unit for managing power modes based on power modes for respective tiers, wherein the power modes for respective tiers are power modes corresponding to the respective tiers determined by the management server.

The power management unit may be configured to, when a power mode is different from a power mode of a corresponding tier and a preset time has elapsed since a last task time, change the power mode to the power mode of the corresponding tier.

In accordance with a further aspect of the present invention to accomplish the above objects, there is provided a method for configuring a storage tier in a torus network-based distributed file system, including managing, by a management server, topology information of data servers, wherein the management server manages one or more metadata servers that store metadata of files in the torus network-based distributed file system, and multiple data servers that are included in the torus network to distribute and store data; and configuring, by the management server, multiple tiers for data servers using the topology information.

Configuring the multiple tiers may be performed to configure the multiple tiers for data servers in consideration of one or more of proximity of each of the data servers to a switch connected to a client and input/output performance of each of the data servers.

The method may further include configuring, by the management server, one or more volumes for the data servers, wherein each of the volumes may be configured such that configuration of the tiers is determined depending on usage of the volume.

The method may further include receiving, by the management server, a migration request for data movement between tiers in a volume composed of multiple tiers; and processing, by the management server, the migration request.

The method may further include determining, by the management server, power modes for respective tiers, corresponding to the respective tiers; and managing, by the management server, power modes corresponding to respective data servers based on the power modes for respective tiers at preset periods.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams illustrating the configuration of a torus network-based distributed file system according to an embodiment of the present invention;

FIG. 3 is a diagram illustrating an example of the structure of a three-dimensional (3D) torus network in a torus network-based distributed file system according to an embodiment of the present invention;

FIG. 4 is a block diagram illustrating an example of the management server illustrated in FIGS. 1 and 2;

FIG. 5 is a block diagram illustrating an example of the metadata server illustrated in FIGS. 1 and 2;

FIG. 6 is a block diagram illustrating an example of the data server illustrated in FIGS. 1 and 2;

FIG. 7 is a diagram illustrating an example of the tier information table of the torus network-based distributed file system according to an embodiment of the present invention;

FIG. 8 is a diagram illustrating examples of topology information and data server information of the torus network of the torus network-based distributed file system according to an embodiment of the present invention;

FIG. 9 is a diagram illustrating an example of volume configuration information of the torus network-based distributed file system according to an embodiment of the present invention;

FIG. 10 is a diagram illustrating an example of the inode table of the torus network-based distributed file system according to an embodiment of the present invention;

FIG. 11 is an operation flowchart illustrating an example of a method in which the management server of the torus network-based distributed file system performs data migration according to an embodiment of the present invention; and

FIG. 12 is an operation flowchart illustrating an example of a method in which the management server of the torus network-based distributed file system operates storage tiers based on a power management policy according to an embodiment of the present invention.

### DESCRIPTION OF THE PREFERRED EMBODIMENTS

The present invention may be variously changed, and may have various embodiments, and specific embodiments will be described in detail below with reference to the attached drawings. The advantages and features of the present invention and methods for achieving them will be more clearly understood from the following detailed description taken in conjunction with the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

However, the present invention is not limited to the following embodiments, but some or all of the following embodiments can be selectively combined and configured, and thus various modifications are possible. In the following embodiments, terms such as “first” and “second” are not intended to restrict the meanings of components, but are merely intended to distinguish one component from other components. A singular expression includes a plural expression unless a description to the contrary is specifically pointed out in context. In the present specification, it should be understood that terms such as “include” or “have” are merely intended to indicate that features or components described in the present specification are present, and are not intended to exclude the possibility that one or more other features or components will be present or added.

Embodiments of the present invention will be described in detail with reference to the accompanying drawings. In the following description of the present invention, the same reference numerals are used to designate the same or similar elements throughout the drawings, and repeated descriptions of the same components will be omitted.

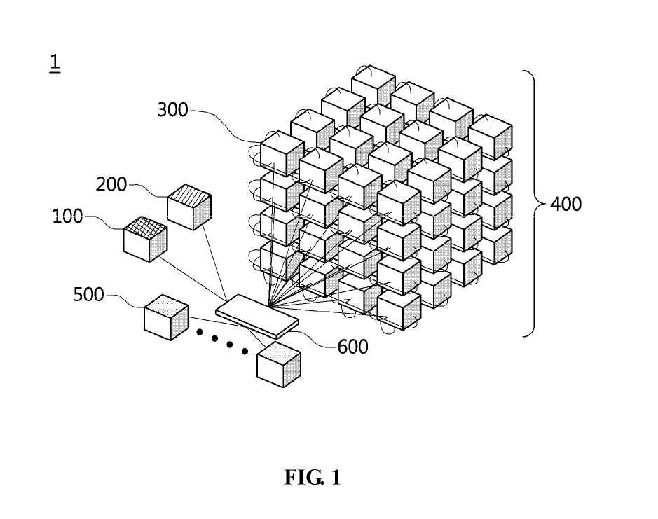

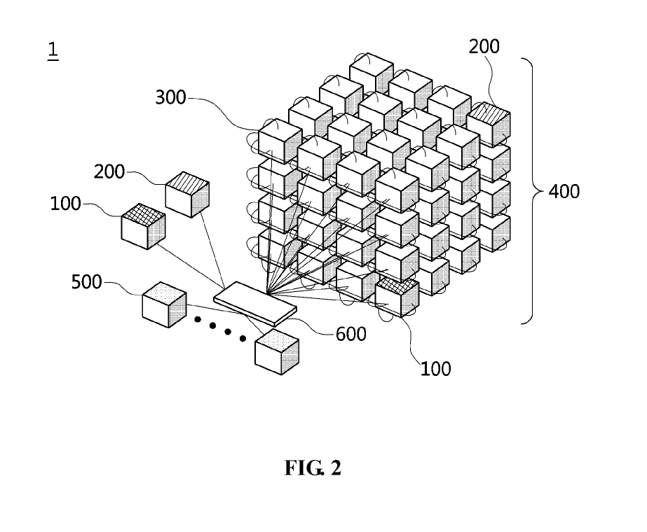

FIGS. 1 and 2 are diagrams illustrating the configuration of a torus network-based distributed file system according to an embodiment of the present invention.

Referring to FIGS. 1 and 2, a torus network-based distributed file system 1 according to an embodiment of the present invention includes multiple data servers 300, one or more metadata servers 200, one or more management servers 100, and a switch 600 based on a torus network 400, wherein the switch 600 is connected to one or more clients 500. Here, FIG. 1 illustrates an example in which the management servers 100 and the metadata servers 200 are located outside the torus network 400 and are directly connected to the switch 600, and FIG. 2 illustrates an example in which some of the management servers 100 and the metadata servers 200 are located inside the torus network 400.

The torus network 400 may have a multidimensional (e.g. n-dimensional) structure. In particular, the torus network 400 may have a 3D structure.

Here, the first plane of the torus network 400 may be connected to the switch 600. The first plane of the torus network 400 may be the hyperplane of the torus network, which is directly connected to the switch 600. That is, when the torus network 400 has an n-dimensional structure, the first plane may be an n-1-dimensional hyperplane directly connected to the switch 600. Hereinafter, the terms “hyperplane” and “plane” may be interchangeably used to have the same meaning.

Here, the torus network 400 may be composed of multiple data servers 300, and may be configured to selectively include one or more metadata servers 200.

The components of the torus network 400 may provide a routing function for network connections of the data servers 300 that are located in the second plane or higher-level planes and that are not connected to the switch, and may establish paths through which they access each other. That is, the data servers 300 may be directly or indirectly connected to the torus network 400 through routing. Therefore, the proximities of respective data servers 300 to the switch 600 may differ, and network delay times occurring when an input/output request is processed may vary depending on the proximities.

The management servers 100 manage the metadata servers 200 and the data servers 300.

Here, the management servers 100 may be implemented using multiple management servers, and may be configured in a server-multiplexing (active-standby) manner.

In this case, the management servers 100 may be independently located outside the torus network 400, and may be directly connected to the switch 600, thus performing communication with the clients 500. Alternatively, the management servers 100 may be located in the first plane of the torus network 400, and may be directly connected to the switch 600, thus communicating with the clients 500. The reason for this is to implement fast access between the management servers 100 and the clients 500. Further, the management servers 100 may be independently located outside the torus network 400, and may then be connected to the switch 600 over a fat-tree network.

Here, the management server 100 may manage topology information of the data servers 300 or the metadata servers 200, and may configure multiple tiers for the data servers 300 or the metadata servers 200 using the topology information. Here, the topology information may include the location information of axes in respective dimensions in the torus network 400. In particular, the tiers may be configured in consideration of one or more of the proximity of each of the data servers 300 or the metadata servers 200 to the switch 600 and the input/output performance of each of the data servers 300 or the metadata servers 200.

Here, each management server 100 may configure one or more volumes for the data servers 300 or the metadata servers 200. Here, in each volume, the configuration of each tier may be determined according to the use or purpose of the volume. For example, a volume to be used for archiving may be configured to include only an archive tier (e.g. the tier having the lowest performance). Further, a volume to be used for the purpose of a Video-On-Demand (VOD) service may be configured to include multiple tiers so that the data most frequently accessed by users is arranged in the tier having the highest performance, data less frequently accessed by users is arranged in the tier having the second-highest performance, and data not accessed by users for a long period of time is arranged in an archive tier.

The management server 100 may distribute and store data in volumes based on erasure coding.

Here, the management server 100 may perform migration for data movement between tiers in the volume composed of multiple tiers. When migration is performed, a migration target inode corresponding to a migration target volume may be identified, a migration target chunk may be identified from the inode, a data server located in a migration destination tier may be determined, data may be moved to the migration destination tier, and then the migration target inode may be updated.

Here, the management server 100 may determine power modes for respective tiers, corresponding to the respective tiers, and may then manage power modes corresponding to respective data servers 300. Here, the power modes for respective tiers may be determined in consideration of one or more of performance and access frequency corresponding to each of the tiers, and may include one or more of a first mode, in which performance is prioritized without power reduction, a second mode, in which operation is performed at low power when an input/output request is not received, and a third mode, in which a power-saving state is maintained when an input/output request is not received. In addition to the exemplified power modes for respective tiers, further subdivided power modes for respective tiers may be used as the occasion demands. In particular, when the power mode of a target data server is different from that of a tier corresponding to the target data server, and a preset time has elapsed since the last task time of the target data server, the power mode of the target data server may be changed to the power mode of the tier corresponding to the target data server.

The metadata servers 200 store and manage the metadata of files managed by the torus network-based distributed file system 1. Here, multiple metadata servers 200 may be configured, and may distribute and store the metadata therein.

The metadata servers 200 may be independently located outside the torus network 400, and may be directly connected to the switch 600, or may be located in an arbitrary plane in the torus network 400. Further, the metadata servers 200 may be independently located outside the torus network 400, and may be connected to the switch 600 over a fat-tree network.

The data servers 300 store and manage actual data of the files managed by the torus network-based distributed file system 1. The data servers 300 configure the torus network 400 through direct connection, without requiring a switch. Here, multiple data servers 300 may be configured in the torus network 400, and may distribute, store, and manage data.

Here, the data servers 300 located in the first plane of the torus network 400 may be directly connected to the switch 600.

The data servers 300 may be directly connected to the metadata servers 200 included in the torus network 400, without requiring a switch.

Here, the data servers 300 may manage power modes based on a power control policy.

The clients 500 may access the torus network-based distributed file system 1 to perform file operations. Here, the clients 500 may be included in the torus network-based distributed file system 1, or may not be included in the torus network-based distributed file system 1.

The clients 500 may communicate with the management servers 100, the metadata servers 200, and the data servers 300 through the switch 600.

Here, there may be multiple clients 500, which may be connected to the switch 600 over the fat-tree network.

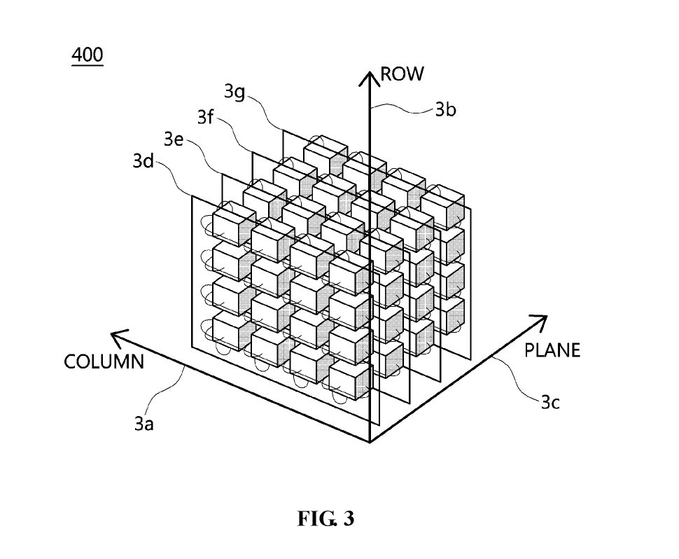

FIG. 3 is a diagram illustrating an example of the structure of a 3D torus network in the torus network-based distributed file system 1 according to an embodiment of the present invention.

Referring to FIG. 3, the 3D torus network 400 in the torus network-based distributed file system 1 according to the embodiment of the present invention may have a 3D structure, and may have a size of 4×4×4.

Here, the 3D torus network 400 may be managed based on topology information corresponding to the locations or coordinates of three axes 3a, 3b, and 3c. For example, in the topology information, an x axis 3a denotes column coordinates, a y axis 3b denotes row coordinates, and a z axis 3c denotes plane coordinates. Here, pieces of information about respective coordinates may be used as network address information.

Here, the data servers having the same plane coordinates may be classified and managed as a single plane 3d, 3e, 3f or 3g. In particular, data servers may be classified into a first plane 3d, a second plane 3e, a third plane 3f, and a fourth plane 3g based on proximity to the switch (see 600 of FIG. 1) or the input/output performance of the data servers. In this case, network delay times required for processing input/output requests received from clients may be increased in the sequence of the first plane 3d, the second plane 3e, the third plane 3f, and the fourth plane 3g. Although not illustrated in FIG. 3, servers located in the first plane 3d may be directly connected to the switch (see 600 of FIG. 1), as illustrated in FIGS. 1 and 2.

Here, tiers may be configured in consideration of the characteristics of the planes of data servers. For example, the first plane 3d may be configured as a first tier, the second plane 3e may be configured as a second tier, the third plane 3f may be configured a third tier, and the fourth plane 3g may be configured as a fourth tier. Alternatively, the first plane 3d and the second plane 3e may be configured as a first tier, the third plane 3f may be configured as a second tier, and the fourth plane 3g may be configured as a third tier.

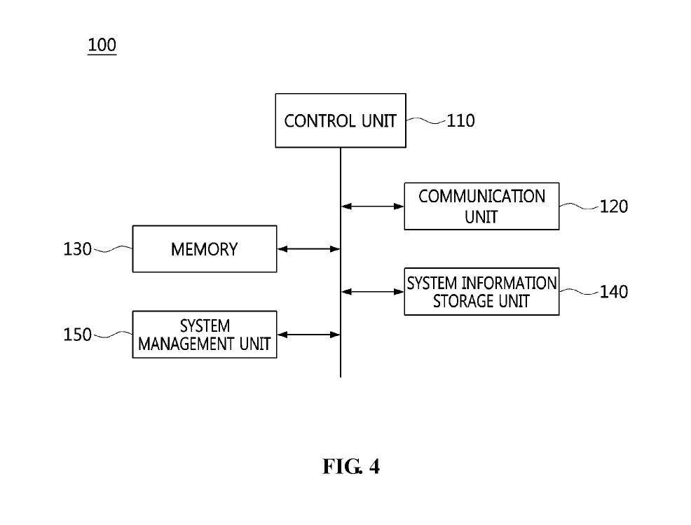

FIG. 4 is a block diagram illustrating an example of the management server 100 illustrated in FIGS. 1 and 2.

Referring to FIG. 4, the management server 100 according to an embodiment of the present invention includes a control unit 110, a communication unit 120, memory 130, a system information storage unit 140, and a system management unit 150.

In detail, the control unit 110, which is a kind of Central Processing Unit (CPU), controls a procedure for managing a torus network-based distributed file system 1. That is, the control unit 110 may provide various functions by controlling the communication unit 120, the memory 130, the system information storage unit 140, and the system management unit 150.

Here, the control unit 110 may include all types of devices capable of processing data, such as a processor. Here, the term “processor” may refer to a data-processing device that has a circuit physically structured to perform functions represented by code or instructions included in a program and that is embedded in hardware. Examples of the data-processing device embedded in hardware in this way may include, but are not limited to, processing devices such as a microprocessor, a CPU, a processor core, a multiprocessor, an Application-Specific Integrated Circuit (ASIC), and a Field-Programmable Gate Array (FPGA).

The communication unit 120 provides a communication interface required for the transfer of transmission/reception signals between the management server 100, a switch (see 600 of FIG. 1), metadata servers (see 200 of FIG. 1), data servers (see 300 of FIG. 1), and clients (see 500 of FIG. 1).

Here, the communication unit 120 may be a device including hardware and software required in order to transmit/receive signals, such as control signals or data signals, to/from other network devices through wired/wireless connection.

The memory 130 functions to temporarily or permanently store data processed by the control unit 110. Here, the memory 130 may include, but is not limited to, magnetic storage media or flash storage media.

The system information storage unit 140 manages information about metadata servers (see 200 of FIG. 1) and data servers (see 300 of FIG. 1) which are managed by the management server 100.

Here, the system information storage unit 140 may store topology information of the servers, data server information, volume configuration information, tier information, inode information, power management policies, etc.

The system management unit 150 manages the metadata servers (see 200 of FIG. 1) and the data servers (see 300 of FIG. 1).

The system management unit 150 may configure storage tiers for the data servers (see 300 of FIG. 1) using the topology information.

Also, the system management unit 150 may configure one or more volumes for the data servers (see 300 of FIG. 1), and may determine the configuration of tiers in each volume. Here, the configuration of tiers in each volume may be determined depending on the usage or purpose of the volume. Further, the system management unit 150 may distribute and store data in individual tiers based on erasure coding.

The system management unit 150 may perform migration for data movement between tiers in each volume composed of multiple tiers.

In this case, the system management unit 150 may establish power management policies for respective data servers (see 300 of FIG. 1), and may manage power modes.

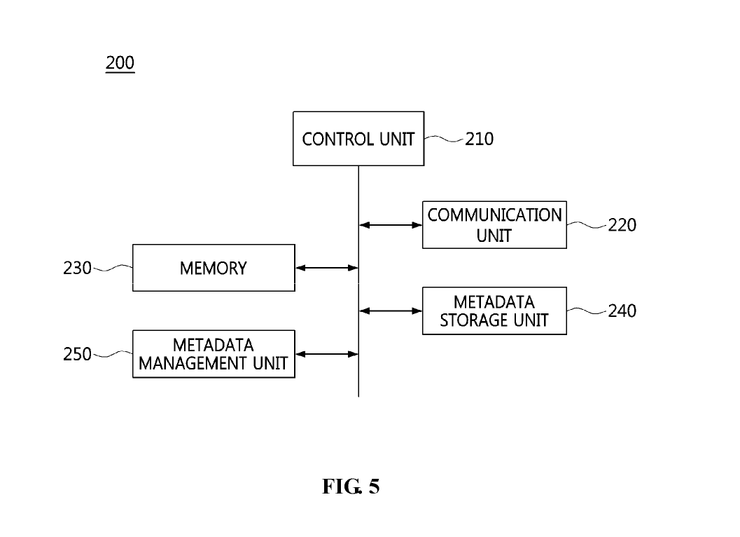

FIG. 5 is a block diagram illustrating an example of the metadata server 200 illustrated in FIGS. 1 and 2.

Referring to FIG. 5, the metadata server 200 according to an embodiment of the present invention includes a control unit 210, a communication unit 220, memory 230, a, metadata storage unit 240, and a metadata management unit 250.

In detail, the control unit 210, which is a kind of CPU, controls a procedure for storing and managing metadata. That is, the control unit 210 may provide various functions by controlling the communication unit 220, the memory 230, the metadata storage unit 240, and the metadata management unit 250.

Here, the control unit 210 may include all types of devices capable of processing data, such as a processor. Here, the term “processor” may refer to a data-processing device that has a circuit physically structured to perform functions represented by code or instructions included in a program and that is embedded in hardware. Examples of the data-processing device embedded in hardware in this way may include, but are not limited to, processing devices such as a microprocessor, a CPU, a processor core, a multiprocessor, an Application-Specific Integrated Circuit (ASIC), and a Field-Programmable Gate Array (FPGA).

The communication unit 220 provides a communication interface required for the transfer of transmission/reception signals between the metadata server 200, a switch (see 600 of FIG. 1), data servers (see 300 of FIG. 1), and clients (see 500 of FIG. 1).

Here, the communication unit 220 may be a device including hardware and software required in order to transmit/receive signals, such as control signals or data signals, to/from other network devices through wired/wireless connection.

The memory 230 functions to temporarily or permanently store data processed by the control unit 210. Here, the memory 230 may include, but is not limited to, magnetic storage media or flash storage media.

The metadata storage unit 240 stores metadata managed by the metadata server 200.

When the metadata server 200 is composed of multiple metadata servers in a distributed file system (see 1 of FIG. 1), the metadata storage unit 240 may distribute and store metadata together with the metadata storage units 240 of other metadata servers 200.

The metadata management unit 250 manages the metadata stored in the metadata storage unit 240. In particular, the metadata management unit 250 may process metadata corresponding to a file in response to a file input/output request received from each client (see 500 of FIG. 1). Also, the metadata management unit 250 may process data stored in the metadata storage unit 240 in response to a command received from the corresponding management server (see 100 of FIG. 1).

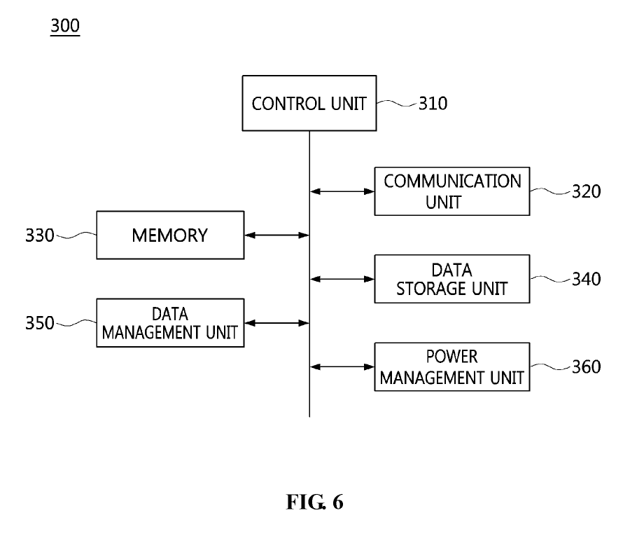

FIG. 6 is a block diagram illustrating an example of the data server 300 illustrated in FIGS. 1 and 2.

Referring to FIG. 6, the data server 300 according to an embodiment of the present invention includes a control unit 310, a communication unit 320, memory 330, a data storage unit 340, a data management unit 350, and a power management unit 360.

In detail, the control unit 310, which is a kind of CPU, controls a procedure for storing and managing data. That is, the control unit 310 may provide various functions by controlling the communication unit 320, the memory 330, the data storage unit 340, the data management unit 350, and the power management unit 360.

Here, the control unit 310 may include all types of devices capable of processing data, such as a processor. Here, the term “processor” may refer to a data-processing device that has a circuit physically structured to perform functions represented by code or instructions included in a program and that is embedded in hardware. Examples of the data-processing device embedded in hardware in this way may include, but are not limited to, processing devices such as a microprocessor, a CPU, a processor core, a multiprocessor, an Application-Specific Integrated Circuit (ASIC), and a Field-Programmable Gate Array (FPGA).

The communication unit 320 provides a communication interface required for the transfer of transmission/reception signals between the data server 300, a switch (see 600 of FIG. 1), management servers (see 100 of FIG. 1), and clients (see 500 of FIG. 1).

Here, the communication unit 320 may be a device including hardware and software required in order to transmit/receive signals, such as control signals or data signals, to/from other network devices through wired/wireless connection.

The memory 330 functions to temporarily or permanently store data processed by the control unit 310. Here, the memory 330 may include, but is not limited to, magnetic storage media or flash storage media.

The data storage unit 340 stores data managed by the data server 300.

Here, the data storage unit 340 may distribute and store data together with the data storage units 340 of the data servers 300 configured in the same volume. In particular, the data storage unit 340 may distribute and store data based on erasure coding.

The data management unit 350 manages the data stored in the data storage unit 340. In particular, the data management unit 350 may process data corresponding to a file in response to a file input/output request received from the corresponding client (see 500 of FIG. 1). Also, the data management unit 350 may process the data stored in the data storage unit 340 in response to a command received from the corresponding management server (see 100 of FIG. 1).

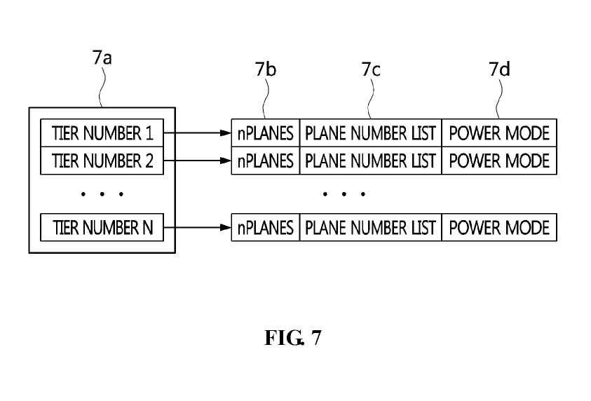

FIG. 7 is a diagram illustrating an example of the tier information table of the torus network-based distributed file system 1 according to an embodiment of the present invention.

Referring to FIG. 7, the tier information table of the torus network-based distributed file system 1 according to the embodiment of the present invention includes configuration information of one or more tiers configured in the torus network-based distributed file system 1. Here, the tiers may be configured based on topology information of the data servers.

The tier information table illustrated in FIG. 7 includes N tiers 7a and pieces of tier configuration information corresponding to respective tiers. Each piece of tier configuration information includes fields for nPlanes 7b, Plane Number List 7c, and Power Mode 7d, and may be configured to include additional information fields in addition to the above fields, if necessary. Here, the nPlanes field 7b indicates the number of planes constituting each tier, and the Plane Number List field 7c indicates a list of the numbers of the planes constituting each tier. Furthermore, the Power Mode field 7d indicates power modes for respective tiers desired to be applied depending on the characteristics of the respective tiers.

Here, the power modes may include a performance priority mode, an operation adaptation mode, a power-saving mode, etc. Here, the performance priority mode may be a mode which is applied to a tier that prioritizes performance and in which storage devices are waiting to process an input/output request with highest priority regardless of power consumption. Further, the operation adaptation mode may be an operating mode in which power consumption is reduced in some aspects such that a CPU is operated in a low-power mode by decreasing the operating frequency of the CPU or such that a storage device is designated to be operated in a low-power mode when an input/output request is not received. Also, the power-saving mode may be a mode in which only the minimum power required in order to awake the storage device is supplied, or in which the power of the corresponding data server is completely interrupted. In this case, the data server must be able to awake from the power-saving mode, if necessary, through a function such as an Intelligent Platform Management Interface (IPMI). In particular, in addition to the above modes, the power modes may be composed of modes having many more steps depending on the circumstances.

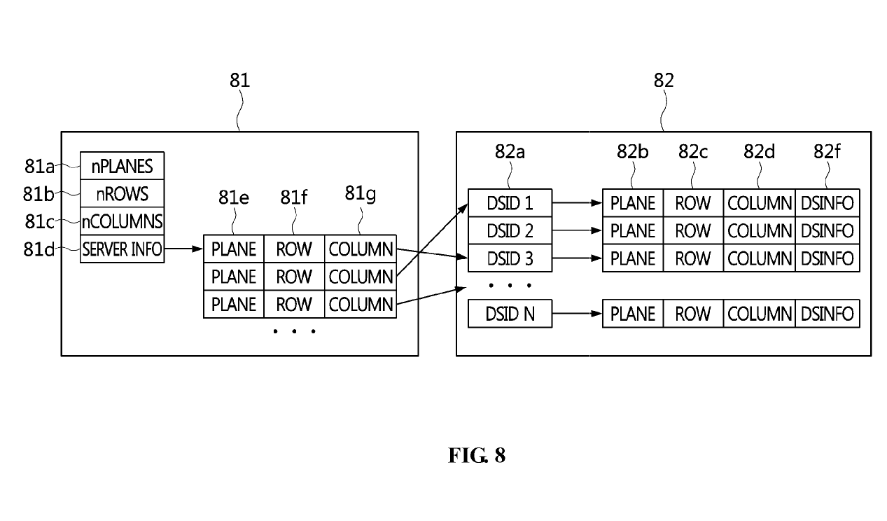

FIG. 8 is a diagram illustrating examples of topology information and data server information of the torus network of the torus network-based distributed file system 1 according to an embodiment of the present invention.

Referring to FIG. 8, topology information 81 of the torus network of the torus network-based distributed file system 1 according to the embodiment of the present invention includes fields for nPlanes 81a, indicating the number of planes of the torus network (see 400 of FIG. 1), nRows 81b, indicating the number of rows, nColumns 81c, indicating the number of columns, and Server Info 81d, indicating table information that points at the locations of data servers (see 300 of FIG. 1).

Here, the Server Info field 81d may indicate the data servers (see 300 of FIG. 1) present in the torus network (see 400 of FIG. 1) using a Plane field 81e, indicating plane coordinates on the torus network, a Row field 81f, indicating row coordinates, and a Column field 81g, indicating column coordinates.

The data server information 82 of the torus network of the torus network-based distributed file system 1 according to an embodiment of the present invention includes fields for Data Server ID (DSID) 82a, indicating the identifier of each data server (see 300 of FIG. 1), and records, indicating information about data servers corresponding to respective DSIDs 82a.

Here, the records, indicating information about data servers corresponding to respective DSIDs 82a, may include fields for topology information 82b, 82c, and 82d of a target data server on the torus network, and DSinfo 82f, containing information about the target data server. Here, the topology information fields may include plane coordinate information 82b, row coordinate information 82c, and column coordinate information 82d, and the DSinfo field 82f may include hardware resource information that contains the network address of the target data server and disk information, such as the types, numbers, and sizes of mounted disks.

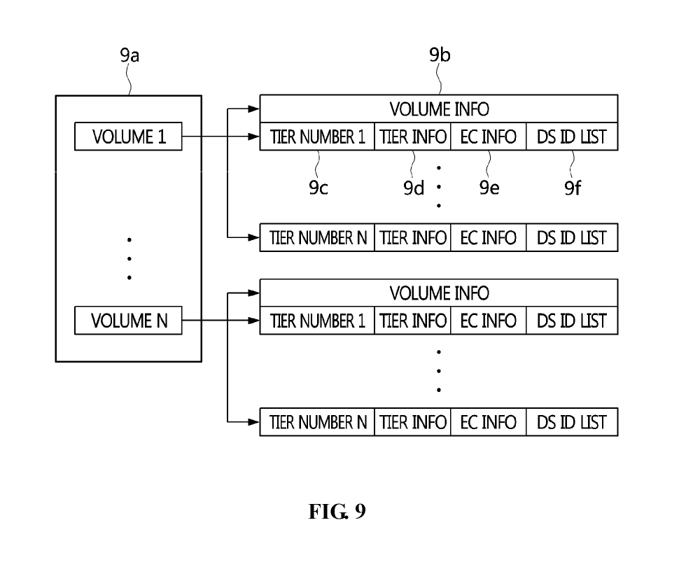

FIG. 9 is a diagram illustrating an example of volume configuration information of the torus network-based distributed file system 1 according to an embodiment of the present invention.

Referring to FIG. 9, the volume configuration information of the torus network-based distributed file system 1 according to the embodiment of the present invention is characterized in that the identifier or volume name of each volume is configured as a volume identification key 9a. Here, the volume may be composed of one or more data servers (see 300 of FIG. 1), and may be configured to include a single tier or multiple tiers depending on the use purpose thereof. For example, a volume to be used for archiving may be configured to include only an archive tier. Further, a volume to be used to provide a VOD service may be configured to include multiple tiers, and may be configured such that the data most frequently accessed by users is arranged in the tier having the highest performance, data less frequently accessed by users is arranged in the tier having the second-highest performance, and data not accessed by users for a long period of time is arranged in an archive tier.

Here, the volume configuration information may include, as detailed information of the volume corresponding to each volume identification key 9a, a volume information (Volume Info) field 9b and tier configuration information fields 9c, 9d, 9e, and 9f constituting the volume.

Here, the volume information 9b may include information such as a volume name, a total volume size, the number of stored files, the amount of the volume that is used, and the remaining space.

The tier configuration information may be composed of a Tier Number field 9c, a tier information (Tier Info) field 9d, an availability policy information (EC Info) field 9e, and a data server ID list (DS ID List) field 9f. Here, the Tier Info field 9d may include information, such as the capacity of a certain tier allocated to the corresponding volume, the amount of the tier that is used, and the remaining capacity. The EC Info field 9e indicates an availability policy that is established depending on the characteristics of each tier. For example, the case where the availability policy is “1+2” may indicate that two duplicates are maintained for each piece of source data. The case where an availability policy is “8+2” may indicate that an erasure coding policy for configuring two pieces of parity data for eight pieces of source data is used. The DS ID List field 9f may indicate a list of IDs of data servers that are allocated from a certain tier to the corresponding volume and that are then used.

As described above, since tier configuration information configuring a volume and the list of IDs of data servers allocated to each tier are included in the volume configuration information, the torus network-based distributed file system may simply detect the structure of the distributed file system, and may then effectively perform file input/output operations.

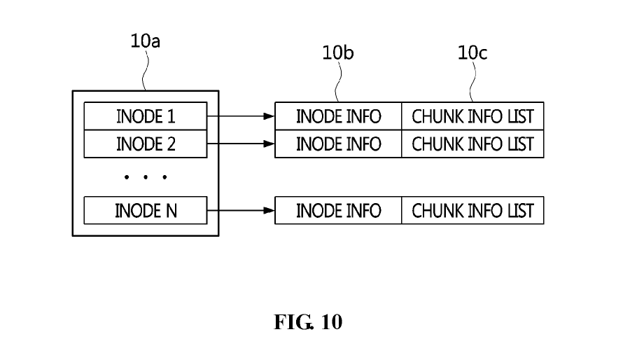

FIG. 10 is a diagram illustrating an example of the inode table of the torus network-based distributed file system 1 according to an embodiment of the present invention.

Referring to FIG. 10, the inode table of the torus network-based distributed file system 1 according to the embodiment of the present invention includes an inode list 10a, in which each inode is composed of an inode information (Inode Info) field 10b and a chunk information list (Chunk Info List) field 10c. Here, the inode may be information for identifying each file.

Here, the inode information field 10b may include inode information required by a system, and the chunk information list field 10c may include information about chunks, which are units resulting from division of data of each file by a fixed size and in which divided data is stored.

The information about chunks may be composed of information such as multiple pieces of source data and multiple pieces of duplicate data or parity data based on an availability policy established in each tier of a volume. Further, the chunk information may include information for identifying data servers that store respective data blocks.

By means of this, a chunk which stores data requested by a user may be identified, and a data server which stores the corresponding chunk and a storage device mounted in the data server may be identified.

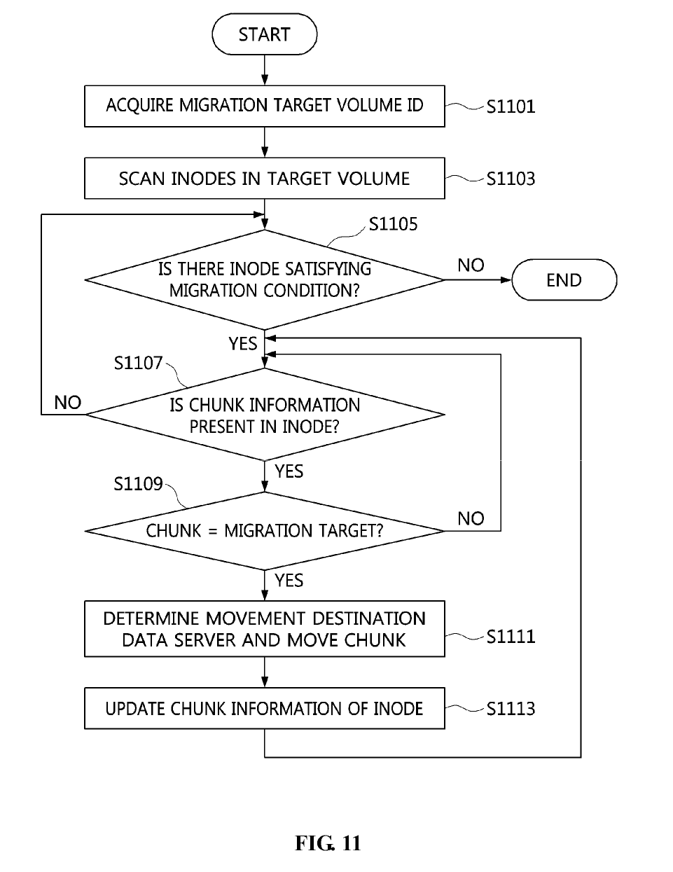

FIG. 11 is an operation flowchart illustrating an example of a method in which the management server 100 of the torus network-based distributed file system performs data migration according to an embodiment of the present invention.

Referring to FIG. 11, the method in which the management server 100 of the torus network-based distributed file system performs data migration according to the embodiment of the present invention acquires a volume ID for identifying a migration target volume from factors transferred during performance of migration at step S1101.

Next, the method in which the management server 100 of the torus network-based distributed file system performs data migration according to the embodiment of the present invention identifies inodes belonging to the corresponding volume by scanning an inode table at step S1103.

Further, the method in which the management server 100 of the torus network-based distributed file system performs data migration according to the embodiment of the present invention determines, for each of the identified inodes, whether an inode that satisfies a migration condition is present among the identified inodes at step S1105.

Here, the migration condition may correspond to information about the time at which a file was generated, information about the time at which the file was last accessed, the size of the file, the type of the file, etc.

If it is determined at step S1105 that there is no inode that satisfies the migration condition, a migration procedure is terminated. If the inode table is scanned at step S1103, but an inode is not found, it may be determined that no inode satisfying the migration condition is present.

If it is determined at step S1105 that an inode satisfying the migration condition is present, whether information about a chunk that actually contains data is present in the corresponding inode is determined at step S1107.

If it is determined at step S1107 that chunk information is not present in the corresponding inode, the process returns to step S1105 of determining, for the remaining inode for which the satisfaction of the migration condition has not yet been determined among the inodes scanned at step S1103, whether the remaining inode satisfies the migration condition.

If it is determined at step S1107 that chunk information is present in the corresponding inode, the chunk information is acquired from the corresponding inode, and whether the chunk is a migration target is determined at step S1109. Here, whether the chunk is a migration target may be determined by checking whether the data server that stores the chunk is present in a source tier that will perform migration.

If it is determined at step S1109 that the chunk is not a migration target, the process returns to step S1107 of determining whether information about each remaining chunk that has not yet been identified is present in the inode.

If it is determined at step S1109 that the corresponding chunk is a migration target, a data server present in a destination tier to which the chunk is to be moved is determined, and the chunk is moved to the data server at step S1111. Here, the destination tier to which the chunk is to be moved must be configured in the corresponding volume, and only the data server belonging to the corresponding volume in the destination tier may be set as a movement (migration) destination. Further, when a destination data server is determined, chunk information to be moved and information about the destination data server may be transferred to a source data server, and thus chunk movement may be performed.

Next, in the method in which the management server 100 of the torus network-based distributed file system performs data migration according to the embodiment of the present invention, when chunk movement has been completed, information about the data server that actually stores the chunk on which migration has been performed is reflected in inode information, and thus the chunk information is updated at step S1113. Further, the process returns to step S1107 of determining whether information about a chunk, on which migration has not yet been processed or which has not yet been identified in the inode, is present. When tasks for all inodes and chunks have been completed, the migration procedure may be terminated.

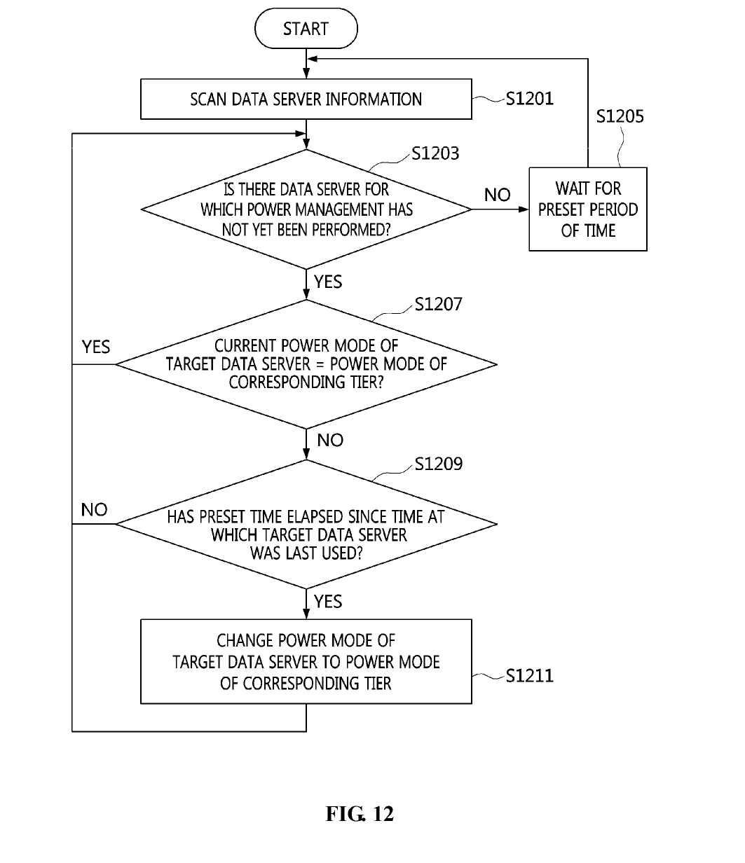

FIG. 12 is an operation flowchart illustrating an example of a method in which the management server 100 of the torus network-based distributed file system operates storage tiers based on a power management policy according to an embodiment of the present invention.

The management server 100 of the torus network-based distributed file system may check the power modes of data servers (see 300 of FIG. 1) based on the power management policy, either periodically or in response to a request, and may manage the data servers depending on power modes for respective tiers.

Referring to FIG. 12, the method in which the management server 100 of the torus network-based distributed file system operates storage tiers based on the power management policy according to the embodiment of the present invention scans information about data servers at step S1201.

Next, the method in which the management server 100 of the torus network-based distributed file system operates storage tiers based on the power management policy according to the embodiment of the present invention determines whether there is a data server, for which power management has not yet been performed, among the scanned data servers in a present power management procedure at step S1203. That is, it is determined whether power management has been performed on all of identified data servers in each power management procedure to be performed either periodically or in response to a request.

If it is determined at step S1203 that a data server, for which power management has not yet been performed, is not present in the corresponding power management procedure, power management is performed on all data servers, and thus the corresponding power management procedure is terminated, and the management server 100 waits for a predetermined period of time at step S1205. That is, the management server 100 of the torus network-based distributed file system may proceed to a subsequent power management procedure after waiting for the predetermined period of time.

If it is determined at step S1203 that a data server, for which power management has not yet been performed, is present in the corresponding power management procedure, data server information corresponding to the data server that is a power management target is analyzed, and whether the current power mode of the target data server is identical to the power mode of the tier to which the target data server belongs is checked at step S1207.

If it is determined at step S1207 that the power mode of the target data server is identical to the power mode of the corresponding tier, power management for the target data server is terminated, and the process returns to step S1203 of determining whether a data server, for which power management has not yet been performed, is present.

If it is determined at step S1207 that the power mode of the target data server is not identical to the power mode of the corresponding tier, whether a preset time has elapsed since the time at which the target data server was last used is determined at step S1209. That is, whether a reference preset time for changing a power mode has elapsed may be checked using the difference between the time at which input/output for data access in the target data server was last performed and the current time.

If it is determined at step S1209 that the preset time has not yet elapsed since the time at which the target data server was last used, the process returns to step S1203 of determining whether there is an additional data server for which power management has not yet been performed.

When it is determined at step S1209 that the preset time has elapsed since the time at which the target data server was last used, the power mode of the target data server is changed to the power mode of the corresponding tier at step S1211, and the process returns to step S1203 of determining whether there is an additional data server for which power management has not yet been performed.

As described above, power modes for respective tiers may be set, and the power modes of data servers may be checked either periodically or in response to a request, so that the data servers may be managed in accordance with the preset power modes for respective tiers, thus operating storage tiers in a power-efficient manner.

Specific executions, described in the present invention, are only embodiments, and are not intended to limit the scope of the present invention using any methods. For simplification of the present specification, a description of conventional electronic components, control systems, software, and other functional aspects of systems may be omitted. Further, connections of lines between components shown in the drawings or connecting elements therefor illustratively show functional connections and/or physical or circuit connections. In actual devices, the connections may be represented by replaceable or additional various functional connections, physical connections or circuit connections. Further, unless a definite expression, such as “essential” or “importantly” is specifically used in context, the corresponding component may not be an essential component for application of the present invention.

In accordance with the present invention, metadata and data may be separated and managed by a torus network-based distributed file system, and thus data may be effectively distributed and managed.

Further, the present invention may configure storage tiers for data servers in consideration of the characteristics of a torus network-based distributed file system, so that the data servers may be managed for respective storage tiers having similar data input/output performance, thus improving the efficiency of data distribution management.

Furthermore, the present invention may operate storage tiers in a torus network-based distributed file system based on an availability policy including duplicates and an erasure coding technique depending the characteristics of storage tiers, and thus the distributed file system may maintain the integrity and availability of files even in the event of failures in some data servers.

In addition, the present invention may operate storage tiers in a torus network-based distributed file system based on power management policies depending on the characteristics of the storage tiers, thus operating individual storage tiers in a power-efficient manner.

Therefore, the spirit of the present invention should not be defined by the above-described embodiments, and it will be apparent that all matters disclosed in the accompanying claims and equivalents thereof are included in the scope and spirit of the present invention.

What is claimed is:

1. A management server, comprising:
a system information storage unit for storing system information of a torus network-based distributed file system;
a system management unit for managing one or more metadata servers that store metadata of files and multiple data servers that are included in the torus network to distribute and store data; and
a communication unit for communicating with a switch connected from a first plane in the torus network or from outside the torus network to a client, and communicating with the metadata servers and the data servers.

2. The management server of claim 1, wherein:
the system management unit manages topology information of the data servers and configures multiple tiers for the data servers using the topology information, and
the topology information includes location information of axes in respective dimensions in the torus network.

3. The management server of claim 2, wherein the system management unit configures the tiers in consideration of one or more of proximity of each of the data servers to the switch and input/output performance of each of the data servers.

4. The management server of claim 3, wherein:
the system management unit configures one or more volumes for the data servers, and
each of the volumes is configured such that configuration of the tiers is determined depending on usage of the volume and such that data is distributed and stored based on erasure coding.

5. The management server of claim 4, wherein the system management unit performs migration for data movement between tiers in a volume composed of multiple tiers.

6. The management server of claim 5, wherein the system management unit is configured to, when performing migration, identify a migration target inode corresponding to a migration target volume, identify a migration target chunk from the inode, determine a data server located in a migration destination tier, move data to the data server, and then update the migration target inode.

7. The management server of claim 4, wherein the system management unit determines power modes for respective tiers, corresponding to the respective tiers, and manages power modes corresponding to the respective data servers based on the power modes for respective tiers at preset periods.

8. The management server of claim 7, wherein the power modes for respective tiers are determined in consideration of one or more of performance and an access frequency corresponding to each of the tiers.

9. The management server of claim 8, wherein the system management unit is configured to, when a power mode of a target data server is different from a power mode of a tier corresponding to the target data server and a preset time has elapsed since a last task time of the target data server, change the power mode of the target data server to the power mode of the tier corresponding to the target data server.

10. A data server, comprising:
a data storage unit for storing data managed by a torus network-based distributed file system;
a data management unit for managing stored data in response to a data-processing command received from a management server; and
a communication unit for communicating with a switch connected from an arbitrary plane in the torus network to a client, either directly or through additional data servers, and communicating with the additional data servers and the management server.

11. The data server of claim 10, wherein:
the data management unit manages data depending on multiple tiers configured by the management server, a volume, and tier configuration corresponding to the volume,
the multiple tiers are configured using topology information including location information of axes in respective dimensions in the torus network, and
the tier configuration corresponding to the volume is determined depending on usage of the volume.

12. The data server of claim 11, wherein the tiers are configured in consideration of one or more of proximity of each of the tiers to the switch and input/output performance of each of the tiers.

13. The data server of claim 12, wherein the data management unit performs migration for data movement between tiers in a volume composed of multiple tiers.

14. The data server of claim 12, further comprising a power management unit for managing power modes based on power modes for respective tiers,
wherein the power modes for respective tiers are power modes corresponding to the respective tiers determined by the management server.

15. The data server of claim 14, wherein the power management unit is configured to, when a power mode is different from a power mode of a corresponding tier and a preset time has elapsed since a last task time, change the power mode to the power mode of the corresponding tier.

16. A method for configuring a storage tier in a torus network-based distributed file system, comprising:
managing, by a management server, topology information of data servers, wherein the management server manages one or more metadata servers that store metadata of files in the torus network-based distributed file system, and multiple data servers that are included in the torus network to distribute and store data; and
configuring, by the management server, multiple tiers for data servers using the topology information.

17. The method of claim 16, wherein configuring the multiple tiers is performed to configure the multiple tiers for data servers in consideration of one or more of proximity of each of the data servers to a switch connected to a client and input/output performance of each of the data servers.

18. The method of claim 17, further comprising configuring, by the management server, one or more volumes for the data servers,
wherein each of the volumes is configured such that configuration of the tiers is determined depending on usage of the volume.

19. The method of claim 18, further comprising:
receiving, by the management server, a migration request for data movement between tiers in a volume composed of multiple tiers; and
processing, by the management server, the migration request.

20. The method of claim 18, further comprising:
determining, by the management server, power modes for respective tiers, corresponding to the respective tiers; and
managing, by the management server, power modes corresponding to respective data servers based on the power modes for respective tiers at preset periods.
